(19) United States
(12) Patent Application Publication
(10) Pub. No.: US 2009/0159828 A1
(43) Pub. Date: Jun. 25, 2009

(54) Valve Gate Piston Retention Device

(75) Inventor: Brian Esser, Colchester, VT (US)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/962,162

(22) Filed: Dec. 21, 2007

(51) Int. Cl. F16K 31/12; F16K 3/00; F16K 3/30; B29B 11/06

(52) U.S. Cl. 251/326; 251/62; 251/324; 425/564

(57) ABSTRACT

A piston and valve stem assembly is held in either a gate open or gate closed position by a valve gate piston retention device until such time as sufficient air pressure is built up behind the piston, upon which the valve gate piston retention device is signaled to release the piston. The piston, being pre-charged, is thereby able to overcome both static and dynamic friction thus allowing it to move freely and immediately, and in the case of multiple pistons, simultaneously or sequentially, and without hesitation. Both simultaneous or sequential retention and release of the piston via mechanical or electromagnetic means can be controlled to actuate a plurality of pistons forward or back in an expeditious manner to overcome pneumatic losses and frictional forces in an effort to achieve more precise timing of the valve stem and optimize overall cycle time.

### TECHNICAL FIELD OF THE INVENTION

The present invention relates to, but is not limited to, injection molding systems, and more specifically the invention relates to a device for controlling the precise timing of the movement of a pneumatically actuated valve gate piston system, by retaining a piston in place, through either a mechanical or electromagnetic device, until a predetermined event or timing sequence is realized. Prior to actuation, air pressure, sufficient to overcome all frictions, losses and resisting forces, is introduced, after or upon which a signal causes release of the retention mechanism retaining the piston thus initiating piston motion.

### BACKGROUND

The nature of single or multiple pneumatically actuated valve gate piston and valve stem assemblies in injection molding is such that they are all subject to variability in the timing of their motion. For those skilled in the art, it is known that rapid and simultaneous movement of the pistons, and ultimately the valve stems, is desirable as valve stem position during the injection molding process affects molded part filling characteristics as well as the overall cycle time of each molding sequence.

Timing variation of pistons and valve stems is due primarily to a combination of three factors, namely: (i) variability in the static and kinetic friction forces on both the piston, via the piston seal rings, and on the valve stem, due to the viscosity of the resin, as well as the fit and clearances to the manifold bushing (ii) the pressurized resin in the mold exerting a force against the valve stem which increases from zero, in the retracted position, and ramps up to a maximum just before the valve stem closes off the gate orifice, and (iii) the compressible nature of the air and the variability of the volume of the air lines, hoses, channels and chambers being used to actuate the piston.

Pneumatic actuation is problematic in that the compressibility of air creates latency and inconsistency in piston movement, as the pressure wave propagation and air pressure losses in the system create variability in the timing of piston motion. This causes problems when it is a requirement that the valve gates must actuate at precise times, either simultaneously or sequentially.

Typically, the pistons in a pneumatically actuated system are controlled by a single master solenoid, which pressurizes each side of all the pistons at once, including all air lines, hoses and chambers between the master solenoid and each piston. The nature of compressible flow and the variability of the force required to actuate the pistons causes them to move at different times. Because the pressure builds from zero gauge pressure, the force on the piston also ramps up proportionally as air rushes in. Each piston in a system begins to move when the force due to air pressure overcomes the forces resisting piston motion. Since there is variability in both forces, the pistons move at different times.

The piston pressure force is variable due to differences in the flow characteristics and the effects of the motion of other pistons increasing the pressurized volume, and the force resisting the piston motion is variable due to different tolerances of the components, variations in frictional forces, and the like.

U.S. Pat. Application Publication No. 2003/0143298, describes an injection molding nozzle utilizing pressurized air to open and close a valve stem and relies merely upon the pressure differential between the inlet and outlet sides of the piston to be satisfactorily dissimilar to enable movement of said piston in one direction, while not accounting for mechanical and pneumatic losses and effects as described above. Again, this arrangement subjects the pistons to inherently variable timing in movement.

U.S. Pat. Application Publication No. 2004/0234645 describes back to back arrays of valve stems used in stack molding, each array being moved as one, either simultaneously or independently, utilizing one plate to carry each array for each mold face. This is accomplished by mechanically linking a plurality of valve stems to a plate which is actuated by a hydraulic, pneumatic or electromechanical driving mechanism. While this invention allows for simultaneous movement of each separate array of valve stems, it precludes individual control of each valve stem of an array for sequential movement and also is subject to timing and motion variability due to the frictional effects of the components and additional mechanical linkages.

Additionally, in one embodiment, each valve stem carrier plate is in turn driven by the same pneumatics as with traditional piston arrangements, and so is subject to the same vulnerabilities as described above, which, in turn, affect an entire array of valve stems. Finally, should one, or more, valve stems of an array be unable to move forward, or back, due to unforeseen circumstances, such as frozen resin due to a failed nozzle heater, or foreign matter contaminating the melt channel, they would undoubtedly cause the entire array to move in an undesirable manner and speed, or in a worst case scenario, the momentum of the moving carrier plate could cause breakage of the lagging valve stem or stems.

U.S. Pat. No. 7,210,922 further describes a valve gate assembly which is driven forward, either hydraulically, pneumatically or mechanically, by an actuation plate yet returned to its original position via springs. Again, while this en masse valve stem actuation ensures simultaneous movement in one direction, it precludes sequential control of any one valve stem, especially with any specific timing specification. Additionally, while the spring force is initially designed to overcome the frictional effects of the components and resin, the spring's consistent performance over time in a predominantly high temperature environment is uncertain, and may not offer exact, simultaneous valve stem retraction as desired.

For the foregoing reasons, the present invention is directed to overcoming one or more of the problems or disadvantages set forth above, and for providing a mechanism which will retain a valve gate piston and valve stem assembly in a gate open or gate closed position until a predetermined pneumatic pressure is accumulated on a side of said piston, sufficient to overcome any and all opposing frictional forces, at which time the mechanism will release the piston for swift and unhindered travel, the timing of which movement may be simultaneous or sequential with neighboring valve stems.

### SUMMARY

The present invention is directed to a retention mechanism which retains a piston, and attached valve stem, in place until such time as compressed air can build up sufficient pressure on one side of the piston, thereby pre-charging the piston with enough energy to overcome friction so that upon release, the piston and valve stem will travel rapidly and uniformly to the next full stop position, thereby minimizing overall molding cycle time. The piston speed is increased due to the higher force present on the piston face before its release resulting in less variable motion initiation. The piston may be retained in either the valve stem retracted, gate open position or the valve stem forward, gate closed position for pre-charging. Additionally, when teamed with a plurality of pistons, the option exists to either release all the pistons in some preferred sequence or simultaneously with a decreased variability in their timing.

In one aspect of the present invention, the piston and valve stem assembly is retained by at least one reciprocating iron core of a solenoid.

In another aspect of the present invention, the piston and valve stem assembly is retained by an electromagnet.

In yet another aspect of the present invention, the piston and valve stem assembly is retained by at least one retracting pin which engages with at least one mating slot in the piston.

In a further aspect of the present invention, the piston and valve stem assembly is retained by at least one retracting roller.

In one aspect of the present invention, the piston and valve stem assembly is retained by at least one retracting lever.

In another aspect of the present invention, the piston and valve stem assembly is retained by at least one pawl which engages with at least one mating slot in the piston.

In another aspect of the present invention, the piston and valve stem assembly is retained by at least one piezoelectric device.

In yet another aspect of the present invention, the retention mechanism is activated by a pneumatic actuator.

In a further aspect of the present invention, the retention mechanism is activated by an actuator which is a solenoid.

In one aspect of the present invention, the retention mechanism is activated by an actuator which is a motor.

In another aspect of the present invention, the actuator is signaled by a controller.

In a further aspect of the present invention, the actuator is signaled by a timer.

In another aspect of the present invention, the actuator is signaled by a transducer.

These and other features, aspects, and advantages of the present invention will become better understood with regard to the following description, appended claims and accompanying drawings.

### BRIEF DESCRIPTION OF THE DRAWINGS

FIG. 1 is a section view assembly of an entire valve gate nozzle stack showing one embodiment of the present invention, namely a solenoid.

FIG. 2 is a section view detail showing a solenoid type retention mechanism retaining the piston in a gate closed position.

FIG. 3 is a section view detail showing a solenoid type retention mechanism retaining the piston in a gate open position, controlled by a transducer.

FIG. 4 is a section view detail showing an electromagnetic type retention mechanism retaining the piston in a gate open position.

FIG. 5 is a section view detail showing a plurality of retracting pins retaining the piston in a gate closed position.

FIG. 6A is a section view detail showing a plurality of retracting rollers retaining the piston in a gate open position with FIG. 6B exchanging rollers for a sliding contact.

FIG. 7 is a section view detail showing a plurality of retracting levers retaining the piston in a gate open position.

FIG. 8 is a section view detail showing a plurality of pawls retaining the piston in a gate closed position.

FIG. 9 is a section view detail showing a piezoelectric device in two possible configurations.

FIG. 10 is a schematic illustrating the complete piston retention and release apparatus showing several possible embodiments.

FIGS. 11A & 11B are section view details of the nozzle tip area showing the valve stem in a gate open and gate closed position respectively.

### DETAILED DESCRIPTION

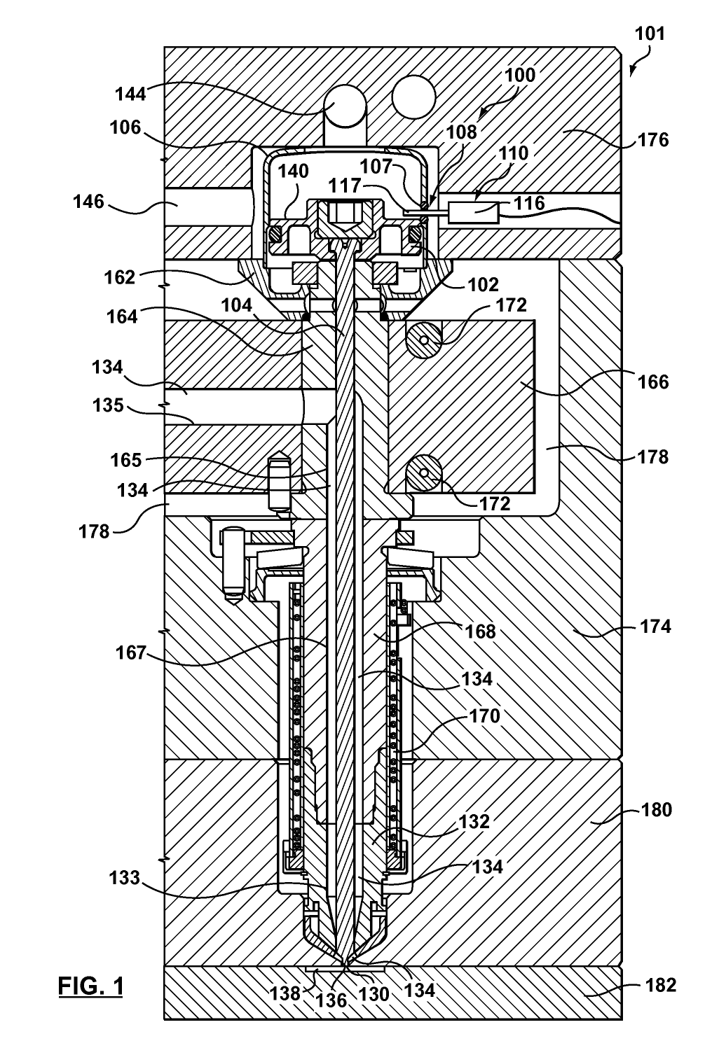

Referring to the drawings, and initially to FIG. 1, a representation of a typical valve gate injection molding nozzle components in a hot runner system 101 is shown, including one embodiment of the present invention; a valve gate piston retention device 100. While FIG. 1 includes one particular retention mechanism 108, specifically an iron core 117, and an actuator 110, in this case, a solenoid 116, the components of the nozzle stack, and in particular, the pneumatically actuated items at the top of the figure, remain common to all embodiments of the present invention. The following description is not intended to describe each and every component of a hot runner system 101, but rather to depict the parts necessary to understand and practice the present invention.

Again, referring to FIG. 1 in more detail, the hot runner system 101 is used to transfer molten resin from an injection molding machine (not shown) through to a gate orifice 136 to create a molded article 138 between a core plate 182 and a cavity plate 180. The resin flow 134 is diverted from a manifold melt channel 135 within a manifold 166, through to a nozzle housing melt channel 167 within a nozzle housing 168 via a manifold bushing melt channel 165 within a manifold bushing 164, wherein the manifold melt channel 135 is in fluid communication with the manifold bushing melt channel 165 and the nozzle housing melt channel 167 is in fluid communication with the manifold bushing melt channel 165. Additionally, a nozzle tip melt channel 133 is in fluid communication with the nozzle housing melt channel 167 as a nozzle tip 132 is operatively, and threadably, attached to the nozzle housing 168.

To maintain optimum temperature of the resin flow 134 throughout the hot runner system 101, the manifold 166 is heated by a manifold heater 172 and the nozzle housing 168 and the nozzle tip 132 are heated by a nozzle heater 170 installed thereon. Both the manifold 166 and the nozzle housing 168 are housed within, but insulated from, a manifold plate 174, by a plurality of air gaps 178 and minimal contact between low thermal conductivity components.

In addition to diverting the resin flow 134, the manifold bushing 164 also secures a backup pad 162 which, in turn, supports a cylinder 106 inside of which travels a piston 102, though the primary function of the manifold bushing 164 is to guide a valve stem 104. The valve stem 104 is removably attached to the piston 102 which, in operation, is caused to reciprocate within the cylinder 106 via air flow entering from either a piston forward air circuit 144 or a piston retract air circuit 146, both of which are plumbed in a backing plate 176.

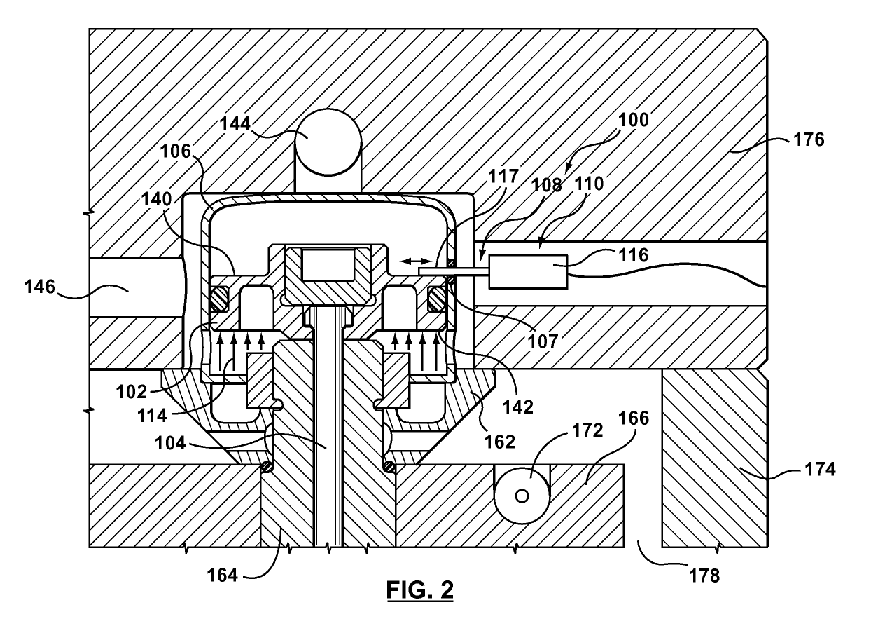

Referring now to FIG. 2, which is a detail of the pneumatic components of the hot runner system 101 shown in FIG. 1, the valve gate piston retention device 100 ensures that the piston 102 is held against, or in close proximity to, the manifold bushing 164 by way of a retention mechanism 108, which, in this embodiment is an iron core 117. The solenoid 116 is the device, in this case, which acts as an actuator 110 to cause the iron core 117 to cycle back and forth through a seal 107 in the cylinder 106 to either retain or release the piston 102 by sliding over the injection side 140 of the piston 102. In this position, compressed air 114, flowing from a piston retract air circuit 146, is allowed to build up under the clamp side 142 of the piston 102, until such time as the iron core 117 is retracted, and the piston 102 and valve stem 104 will travel to the gate open position 126.

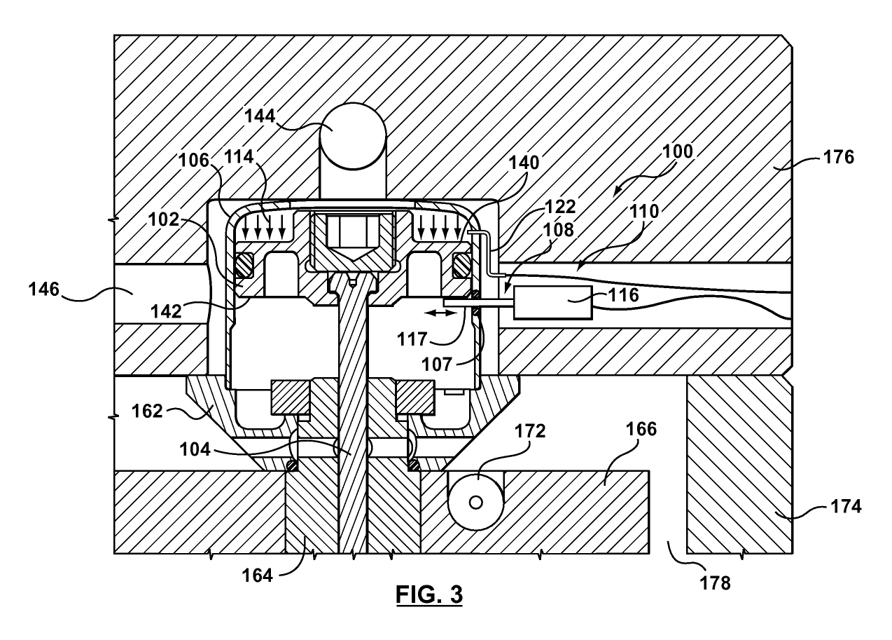

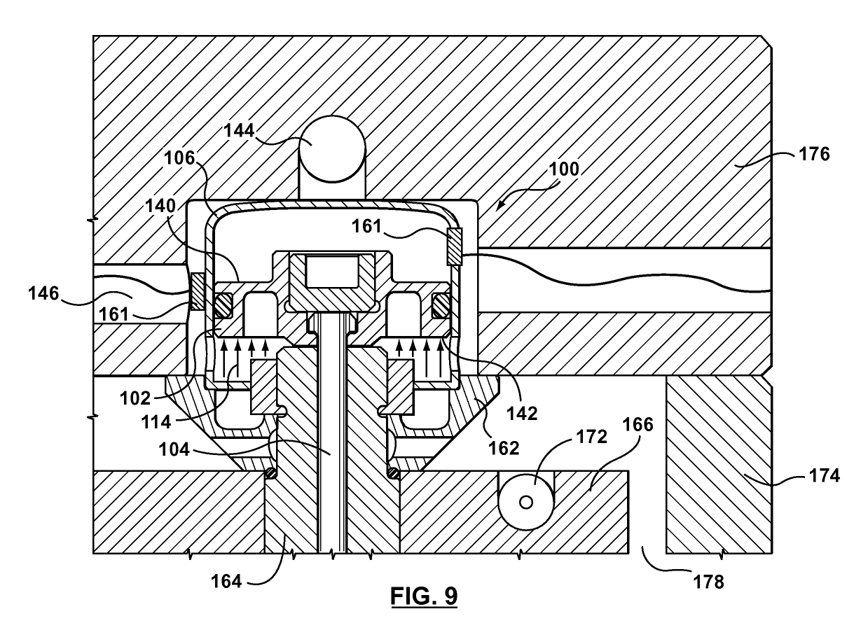

Turning now to FIG. 3, the piston 102 is shown in the retracted or gate open position 126. The embodiment of this invention varies slightly from that shown in FIG. 2, in that the retention mechanism 108; the iron core 117, and the actuator 110; in this case, the solenoid 116, is retaining the piston 102 while compressed air 114, entering from a piston forward air circuit 144, builds up on the injection side 140 of the piston 102. A transducer 122, shown in FIG. 3, is located such that it may sense the pressure behind the piston 102 and will feed that information back to a controller 120, as shown in FIG. 9. Additionally, referring to FIG. 3, the transducer 122 may also be located in the resin flow 134 of the manifold 166, manifold bushing 164, nozzle housing 168, nozzle tip 132, cavity plate 180, or mold cavity 184 in order to sense plastic pressure for feedback purposes.

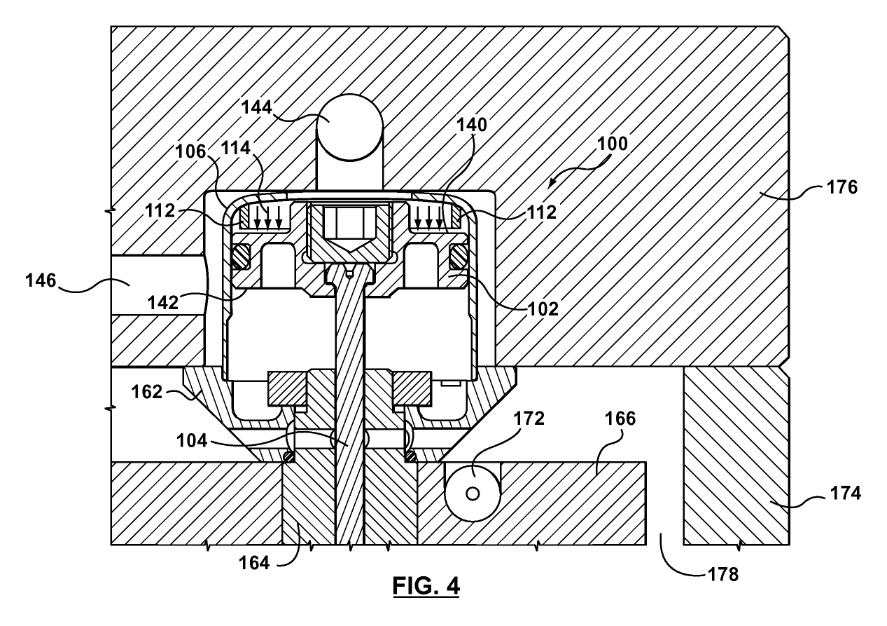

FIG. 4 presents yet another embodiment of the present invention, that being a retention mechanism 108 that is an electromagnet 112. Though this particular rendering shows the electromagnet 112 attached to the top of the cylinder 106, it may be noted that, in the case of other dissimilar configurations of the cylinder 106, the electromagnet 112 will be located proximate to, but not attached directly to, the injection side 140 or the clamp side 142 of the piston 102. The piston 102 may be retained in either the retracted or gate open position 126 or the forward or gate closed position 128, or both positions, by such an electromagnet 112, allowing the compressed air 114 to build up, until such time as power to the electromagnet 112 is removed, thereby rapidly releasing the piston 102 and allowing the compressed air 114 to drive the piston 102. Additionally, if an electromagnet 112 were placed at both positions, an attractive force field could be applied to each respective electromagnet 112, to hasten travel of the piston 102.

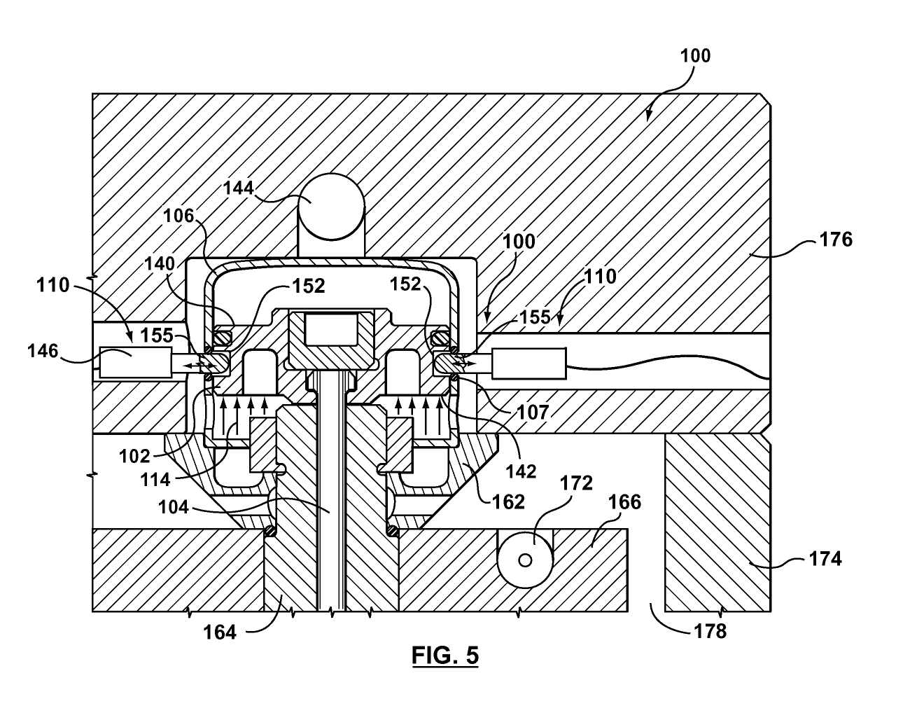

Referring now to FIG. 5, a further embodiment is illustrated in the form of a retracting pin 155 which engages a groove 152 in the piston 102. The retracting pin 155 will withdraw to a position where the piston 102 is free to translate until such time as the retracting pin is energized by an actuator 110 to insert itself through the seal 107 in the cylinder 106 back into the groove 152 in the piston 102. The retracting pin 155 may engage and retain the piston 102 at both the gate open position 126 and the gate closed position 128, depending on the application, while allowing compressed air 114 to pressurize the area behind the piston 102.

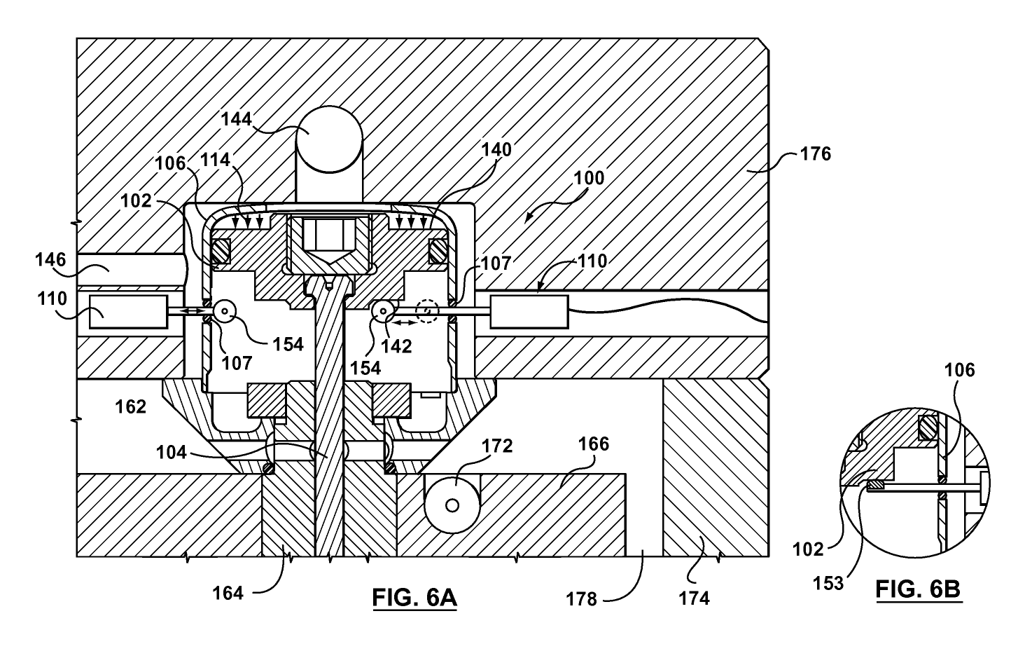

FIG. 6A depicts yet another embodiment of the present invention whereby the valve gate piston retention device 100 is in the form of a roller 154. Similar to the retracting pin 155 as illustrated in FIG. 5, the roller 154 extends and retracts into the cylinder 106, through the seal 107, such that roller 154 makes contact with the clamp side 142 of the piston 102 thus preventing the piston 102 from moving while compressed air 114 builds up behind it on the injection side 140 of the piston 102. The action of the roller 154 is controlled by an actuator 110 which causes it to extend or retract dependent upon the desired position of the piston 102. FIG. 6B shows a slight variation of this embodiment wherein the roller is replaced with a sliding contact 153.

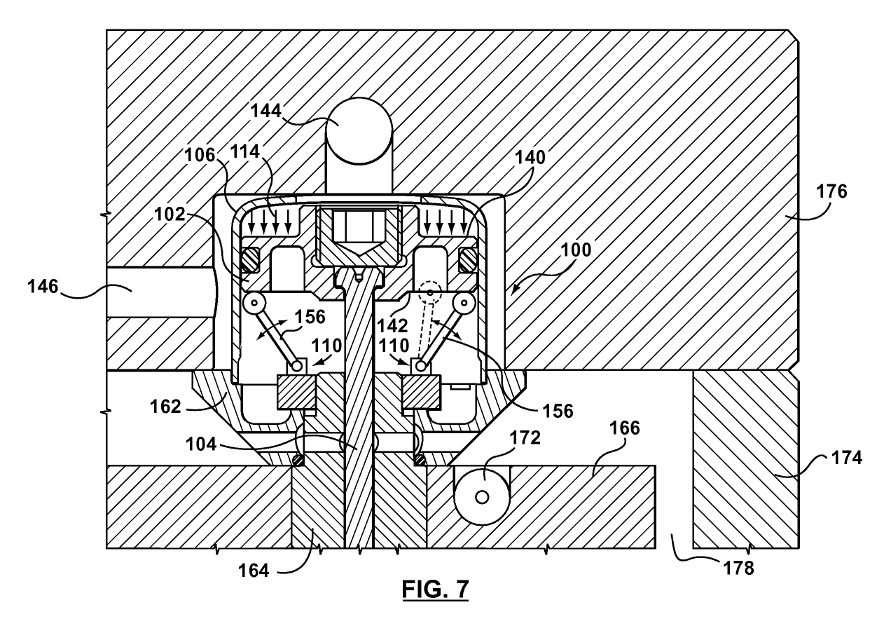

Yet another embodiment is illustrated in FIG. 7 whereby the piston 102 and valve stem 104 are held in place by a retracting lever 156 which, when driven by the actuator 110, pivots in and out of the path of the piston 102, again, retaining it in place to allow compressed air 114 to pre-charge the piston 102 before release. The key aspect of this embodiment as compared to the previous roller 154 design is the pivoting action of the retracting lever 156 versus the linear travel of the roller 154.

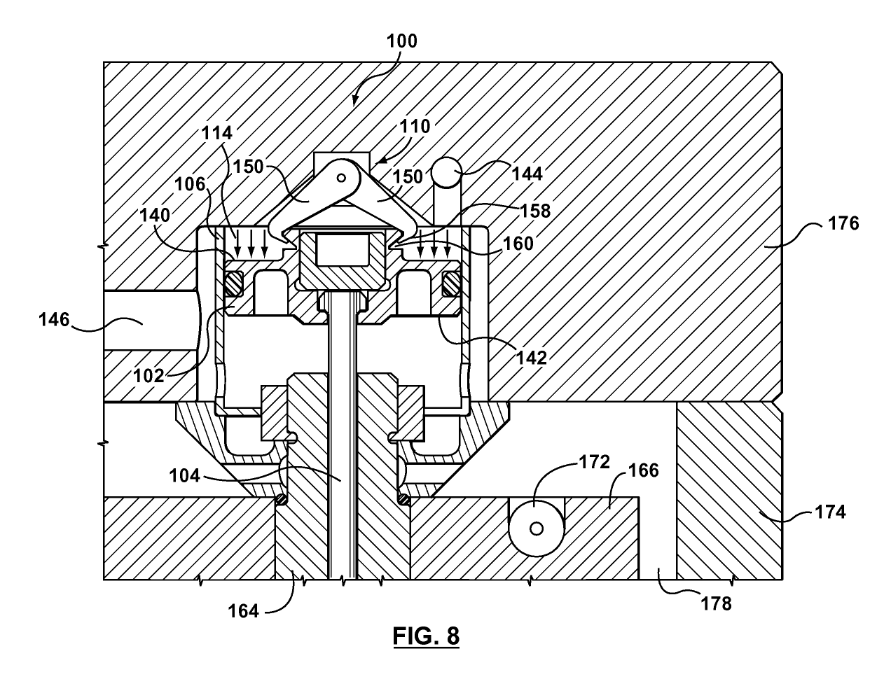

Referring to FIG. 8, a plurality of pawls 150 are used to secure the piston 102 while allowing compressed air 114 to build up behind the injection side 140 of the piston 102. The plurality of pawls 150 pivots to engage a plurality of fingers 158 into a slot 160 in the piston 102. Once the actuator 110 is signaled to release the piston 102, the plurality of pawls 150 opens sufficiently for the plurality of fingers 158 to disengage the piston 102.

FIG. 9 shows two different placements of a piezoelectric device 161, one attached to the outer diameter of the cylinder 106 and one installed through the wall of the cylinder 106. In the former position, the cylinder 106 is sufficiently compliant such that the force from the piezoelectric device 161 which is energized is enough to temporarily deform the inner diameter of the cylinder 106 to cause it to retain the piston 102 when it is proximate to said piezoelectric device 161. Alternatively, when the piezoelectric device 161 is installed through the wall of the cylinder 106, it is permitted to grip the piston 102 itself when energized.

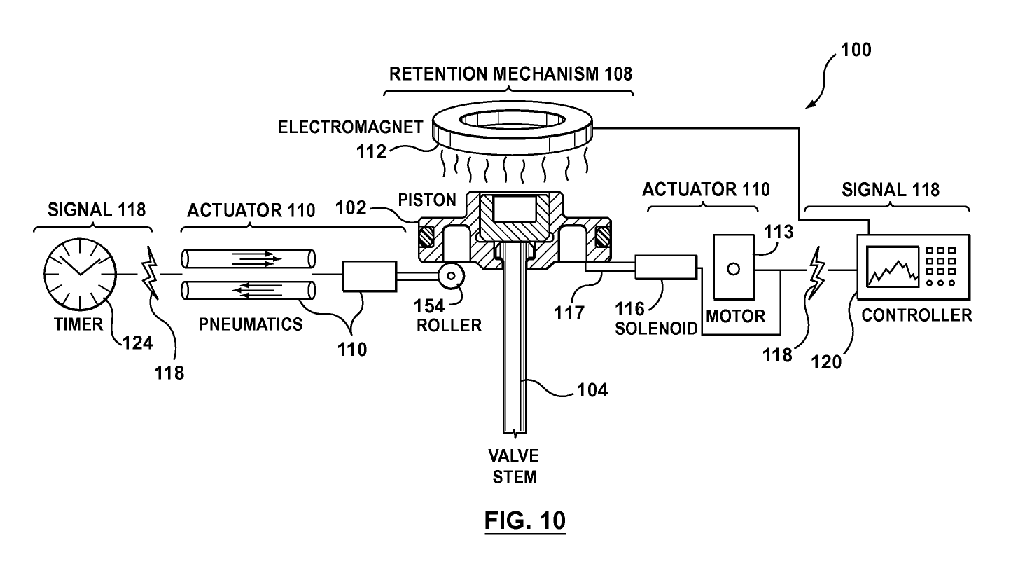

FIG. 10 illustrates the process required to fulfill the sequence of events which enable pre-charging of the piston 102 pneumatically. Central to the figure is the valve stem 104 which is operatively attached to the piston 102. The piston 102 is retained in place by a retention mechanism 108, three variations of which are shown, namely; an electromagnet 112, a roller 154, and an iron core 117.

The retention mechanism 108 is activated to either retain or release the piston 102 by a separate component which is the actuator 110. The actuator 110 may be a solenoid 116, a pneumatic device 111 or a motor 113. The actuator 110 is provided a signal 118 to move or energize the retention mechanism 108, the signal 118 originating from a timer 124 or a controller 120, with the intention of releasing a plurality of pistons 102 simultaneously or sequentially. The retention mechanism 108 may be positioned such that it retains the piston 102 in either the gate open position 126 or the gate closed position 128 or both.

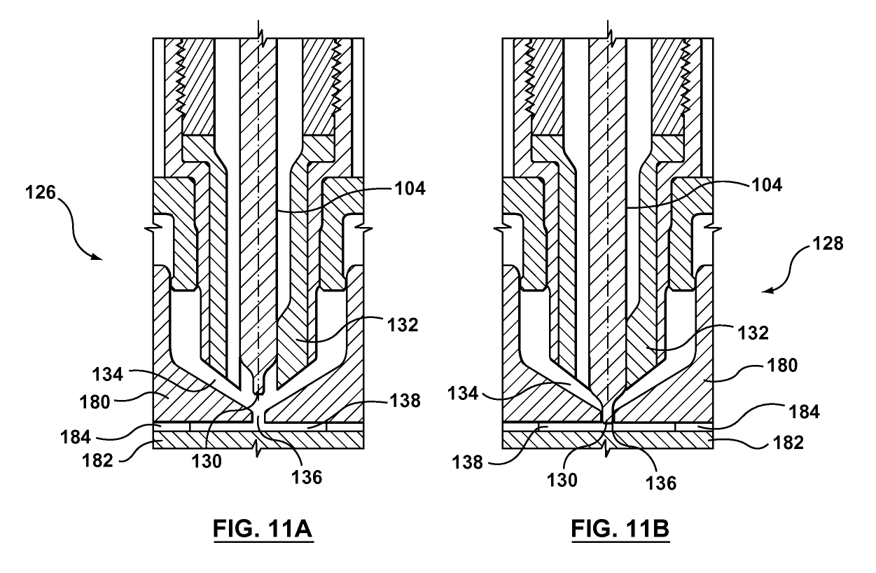

By referring to FIGS. 11A and 11B, the relationship between the valve stem 104 and its interaction with a gate orifice 136 may be elucidated. In FIG. 11A, the valve stem 104 is shown in a retracted or a gate open position 126, while FIG. 11B shows the valve stem 104 in a forward or a gate closed position 128. In the gate open position 126, a valve stem tip 130 is located sufficiently far away from the gate orifice 136 such that resin flow 134 is allowed to migrate through the nozzle tip 132, through the gate orifice 136 and into the mold cavity 184 created by the cavity plate 180 and the core plate 182, and forms the molded article 138. In the gate closed position 128, the valve stem tip 130 is in a fully forward position and so precludes the resin flow 134 from entering the gate orifice 136 and hence the mold cavity 184.

Description of the embodiments of the present inventions provides examples of the present invention, and these examples do not limit the scope of the present invention. It is to be expressly understood that the scope of the present invention is limited by the claims. The concepts described above may be adapted for specific conditions and/or functions, and may be further extended to a variety of other applications that are within the scope of the present invention.

Having thus described the embodiments of the present invention, it will be apparent that modifications and enhancements are possible without departing from the concepts as described. Therefore, what is to be protected by way of letters patent are limited by the scope of the following claims:

What is claimed is:

1. A valve gate piston retention device comprising:
a piston operatively attached to a valve stem
a cylinder for housing at least a portion of the piston
a retention mechanism for retaining the piston;
an actuator for activating the retention mechanism; and
a signal to initiate action of the actuator.

2. The valve gate piston retention device according to claim 1, wherein the piston is pneumatically actuated.

3. The valve gate piston retention device according to claim 1, wherein the retention mechanism is an electromagnet.

4. The valve gate piston retention device according to claim 1, wherein the retention mechanism includes mechanical elements.

5. The valve gate piston retention device according to claim 1, wherein the actuator for the retention mechanism is a solenoid.

6. The valve gate piston retention device according to claim 1, wherein the actuator for the retention mechanism is pneumatic.

7. The valve gate piston retention device according to claim 1, wherein the signal for the actuator is derived from a controller.

8. The valve gate piston retention device according to claim 1, wherein the signal for the actuator is derived from the output of a transducer.

9. The valve gate piston retention device according to claim 1, wherein the signal for the actuator is configured to originate from a timer.

10. A method for retaining a piston, comprising the steps of:
attaching a valve stem to a piston;
reciprocating the piston within a cylinder to a position selected from a gate open position, a gate closed position and combinations thereof;
signaling an actuator to activate a retention mechanism;
activating the retention mechanism with the actuator; and
securing the piston via the retention mechanism.

11. The method according to claim 10, further comprising the step of:
pneumatically actuating the piston.

12. The method according to claim 10, further comprising the step of:
securing the piston with an electromagnet being the retention mechanism.

13. The method according to claim 10, further comprising the step of:
securing the piston with mechanical elements being the retention mechanism.

14. The method according to claim 10, further comprising the step of:
activating the retention mechanism with a solenoid.

15. The method according to claim 10, further comprising the step of:
initiating a signal to the actuator from a controller.

16. A method for pre-charging a piston, comprising the steps of:
translating a piston in a cylinder to a gate open position;
securing the piston with a retention mechanism; and
pressurizing an injection side of the piston with compressed air.

17. A method for pre-charging a piston, comprising the steps of:
translating a piston in a cylinder to a gate closed position;
securing the piston with a retention mechanism; and
pressurizing a clamp side of the piston with compressed air.

18. The method according to claims 16 or 17, further comprising the step of:
releasing a plurality of pistons simultaneously.

19. The method according to claims 16 or 17, further comprising the step of:
releasing a plurality of pistons sequentially.

20. A valve gate piston retention device for use in a hot runner system, comprising:
a piston having a valve stem attached thereto, the piston being configured to reciprocate within a cylinder;
a retention mechanism being configured to engage the piston;
an actuator being configured to activate the retention mechanism; and
a signal for initiating action of the actuator.

21. The valve gate piston retention device according to claim 20, wherein the retention mechanism includes mechanical elements.

22. The valve gate piston retention device according to claim 20, wherein the actuator is a piezoelectric device.

23. The valve gate piston retention device according to claim 20, wherein the signal to the actuator is initiated from a controller.
